(19) United States
(12) Patent Application Publication
(10) Pub. No.: US 2012/0006183 A1
(43) Pub. Date: Jan. 12, 2012

(54) AUTOMATIC ANALYSIS AND MANIPULATION OF DIGITAL MUSICAL CONTENT FOR SYNCHRONIZATION WITH MOTION

(75) Inventor: Eric J. HUMPHREY, Coral Gables, FL (US)

(73) Assignee: UNIVERSITY OF MIAMI, Miami, FL (US)

(21) Appl. No.: 12/830,821

(22) Filed: Jul. 6, 2010

(51) Int. Cl. G10H 1/40

(52) U.S. Cl. 84/611

(57) ABSTRACT

Systems and methods are provided for extracting rhythmic chroma information from a signal. A method may perform a process for rhythmic event perception, periodicity estimation, and chroma representation. Such a process may be implemented by a digital signal processor. The method may further include time-stretching a music signal so that a rhythm of the music signal matches a rhythm of motion detected by a motion sensor.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a method and system for rhythmic auditory quantification and synchronization of music with motion.

### BACKGROUND OF THE INVENTION

Digital multimedia is now an integral aspect of modern life. For example, personal handheld devices, such as the I-Pod™ are designed to streamline the acquisition, management and playback of large volumes of content. As a result, individuals are accessing, storing and retrieving more music than ever, resulting in a logistical problem of indexing, searching, and retrieval of desired content.

Conventional music libraries employ metadata to organize the content of music in the library, but are typically limited to circumstantial information regarding each music track, such as the name of the artist, year of publication, and genre. Content-specific metadata has heretofore required human listeners to characterize music. Human listening has proved to be reliable but time consuming and impractical considering the millions of music tracks available.

The development of computational algorithms, such as beat extraction, has enabled the extraction of meaningful information from music quite rapidly. However, no computational solution has been able to rival the performance and versatility of characterization by human listeners. Therefore, a new computational process for characterizing sound and music is desired.

### SUMMARY OF THE INVENTION

The present invention advantageously provides a method and system for characterization of sound, generally, and music in particular. Features include a method for characterizing sound. The sound may be included in a received audio signal representative of the sound. The method includes obtaining rhythmic chroma data by processing the audio signal. The rhythmic chroma data includes a distribution associated with a rhythm of the sound. The distribution has a peak amplitude at a principal frequency of rhythmic events and has a width associated with a modulation of the rhythmic events.

Another example is a sound analyzer that includes a digital signal processor configured to extract rhythmic chroma information from a first signal representative of the sound. The rhythmic chroma information has a distribution associated with rhythm embedded in the first signal. The distribution exhibits a peak amplitude at a principle frequency of rhythmic events and exhibits a width associated with a modulation of the rhythmic events. In some embodiments, the digital signal processor is further configured to increase or decrease the rhythm of the sound to match a rhythm embedded in a second signal.

Another example is a computer readable medium having instructions that when executed by the computer causes the computer to extract rhythmic chroma data from a signal. The rhythmic chroma data has a distribution associated with a rhythm of the signal. The distribution has a peak amplitude at a principal frequency of rhythmic events carried by the signal. A width of the distribution is a function of a modulation of the rhythmic events.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a digital signal processor operable to extract rhythmic chroma information from a signal;

FIG. 2 depicts a cochlear modeler and a rhythmic event detector that may be implemented by the digital signal processor of FIG. 1;

FIG. 3 depicts a periodicity estimator and a chroma transformer that may be implemented by the digital signal processor of FIG. 1;

FIG. 4 depicts an example distribution of rhythmic chroma data;

FIG. 5 depicts a system for matching a rhythmic frequency of music to a rhythmic frequency of motion; and

FIG. 6 depicts a flowchart for matching a rhythmic frequency of music to a rhythmic frequency of motion.

### DETAILED DESCRIPTION OF THE INVENTION

Systems and methods are provided for extracting rhythmic chroma information from a signal. A method may perform a process for rhythmic event perception, periodicity estimation, and chroma representation. Such a process may be implemented by a digital signal processor. The method may further include time-stretching a music signal so that a rhythm of the music signal matches a rhythm of motion detected by a motion sensor.

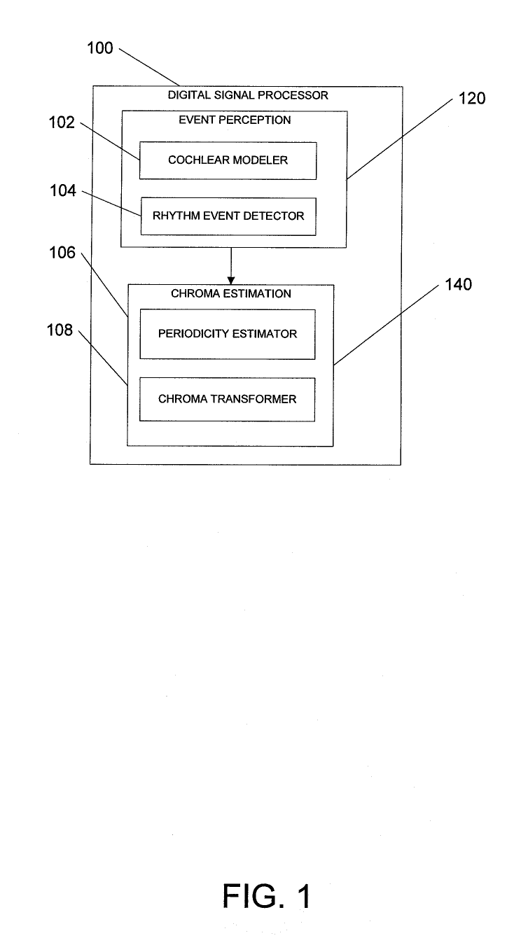

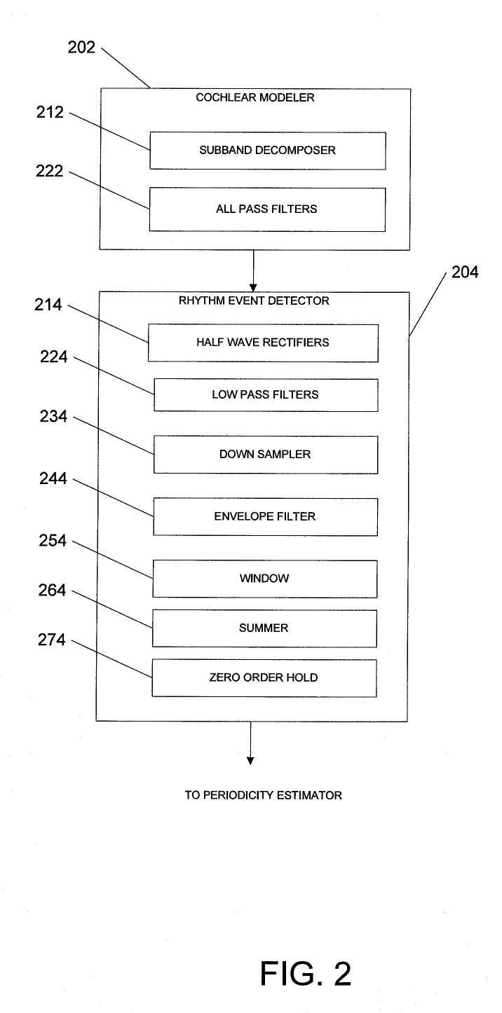

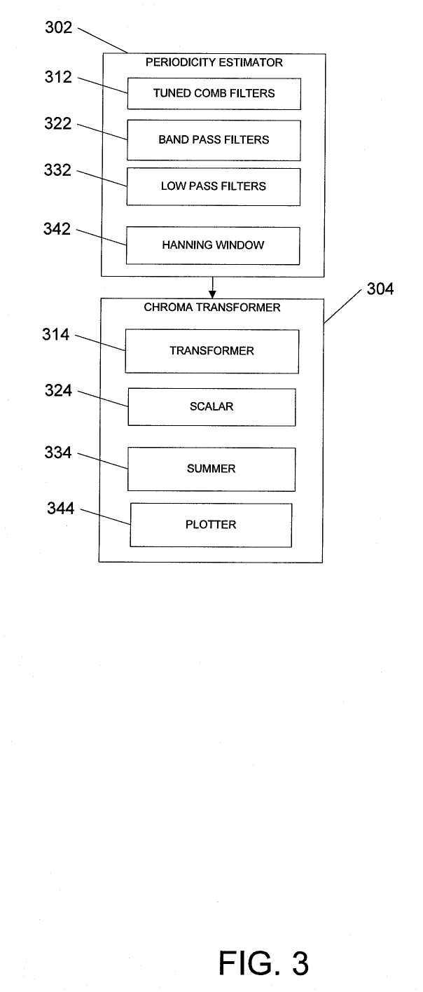

FIG. 1 depicts a digital signal processor 100 operable to extract rhythmic chroma information from a signal. An algorithm that may be executed by the digital signal processor 100 comprises rhythmic event perception 120 and chroma estimation 140. The rhythmic event perception algorithm 120 may include a cochlear modeler 102 and a rhythm event detector 104. The chroma estimation algorithm 140 may include a periodicity estimator 106 and a chroma transformer 108. The event perception algorithm 120 models an aspect of an auditory process of the inner ear and detects rhythm in a sound signal. The chroma estimation algorithm 140 estimates a periodicity of the detected rhythm and transforms the periodicity information to a chroma distribution. These functional entities of FIG. 1 are discussed in detail with reference to FIGS. 2 and 3.

FIG. 2 depicts a cochlear modeler 202 and a rhythmic event detector 204 that may be implemented by the digital signal processor of FIG. 1. The cochlear modeler 202 models coarse frequency decomposition performed by the cochlea of an inner ear. Accordingly, a sub band decomposer 212 decomposes a sound signal into critical bands corresponding to critical bands of preconcious observation of rhythmic events by an auditory system. In particular, a cochlear process of an auditory system may be modeled by a multi-resolution time-domain filter bank. In one embodiment the filter bank includes half-band Finite Impulse Response (FIR) filters of order N=40 with Daubechies' coefficients. For example, the critical bands of a human cochlea may be simulated by twenty two maximally flat sub band filters whose frequency ranges are depicted in Table 1.

TABLE 1

| BAND | RANGE (Hz) | BAND | RANGE (Hz) |
|---|---|---|---|
| 1 | 0-125 | 12 | 1750-2000 |
| 2 | 125-250 | 13 | 2000-2500 |
| 3 | 250-375 | 14 | 2500-3000 |
| 4 | 375-500 | 15 | 3000-3500 |
| 5 | 500-625 | 16 | 3500-4000 |
| 6 | 625-750 | 17 | 4000-5000 |
| 7 | 750-875 | 18 | 5000-6000 |
| 8 | 875-1000 | 19 | 6000-8000 |
| 9 | 1000-1250 | 20 | 8000-10000 |
| 10 | 1250-1500 | 21 | 10000-12000 |
| 11 | 1500-1750 | 22 | 12000-16000 |

Non linear phase distortion caused by the sub band filters of the sub band decomposer 212 is compensated by the all pass filters 222, which are designed to flatten the group delay introduced by the FIR filters of the sub band decomposer 212.

In other embodiments, a time domain signal may be transformed into the frequency domain by a Fast Fourier Transform or more particularly by a Short Time Fourier Transform (STFT). The Fourier coefficients may then be grouped or averaged to define desired sub frequency bands. The signals in these sub frequency bands may then be processed to detect rhythmic event candidates.

Following decomposition, in one embodiment, the rhythmic event detector 204 includes half wave rectifiers 214 for each sub band filter of the sub band decomposer 212. The half wave rectified signals are low pass filtered by low pass filters 224. In some embodiments the low pass filtering may be accomplished using a half-Hanning window defined by the following equations.

$${X}_{{HWR}_{k}} [ n ] = max ( {X}_{k} [ n ] , 0 )$$

$${E}_{k} [ n ] = {\sum }_{i = 0}^{{N}_{k} - 1} {X}_{{HWR}_{k}} [ n ] * {W}_{k} [ i - n ]$$

The outputs of the low pass filters 224 are sub band envelope signals. These sub band envelope signals may then be uniformly down-sampled by a down sampler 234 to a sampling rate of about 250 Hertz (Hz), which sampling rate is based on knowledge of the human auditory system. Other sampling rates may be selected based on an auditory system of some other living being. The down sampled signals may then be compressed according to the following equation.

$${E}_{{C}_{k}} [ n ] = \frac{{log}_{10} ( 1 + μ * {E}_{k} [ n ] )}{{log}_{10} ( 1 + μ )}$$

where μ is in the range of [10, 1000].

The down sampled compressed signals are applied to an envelope filter 244 to determine rhythmic event candidates. The frequency response of the envelope filter 244 may be in the form of a Canny operator defined by the following equation.

$$C [ n \} = \frac{- n}{{σ}^{2}} exp ( - n / 2 {σ}^{2} )$$

where n=[−L, L], and σ is in the range of [2, 5], and L is in the range of about 0.02*F_{S} to 0.03*F_{S} samples, where F_{S} is the given sample rate.
The Canny filter may be more desirable than a first order differentiator because it is band limited and serves to attenuate high frequency content. The output of the envelope filter 244 is a sequence of rhythm event candidates that may effectively represent the activation potential of their respective critical bands in the cochlea. A window 254 is applied to this output to model the necessary restoration time inherent in a chemical reaction associated with neural encoding in an auditory system of a human being or other living being. For a human, the window may be selected to be about 50 milli-seconds wide, with 10 milli-seconds before a perceived event and about 40 milli-seconds after a perceived event. The windowing may eliminate imperceptible or unlikely event candidates.

The sub band candidate events are then summed by a summer 264 to produce a single train of pulses. A zero order hold 274 may be applied to reduce the effective frequency of the pulses. Rhythmic frequency content typically exists in the range of 0.25 to 4 Hz (or 15-240 beats per minute (BPM)). Therefore, a zero order hold of about 50 milli-seconds may be applied to band-limit the signal and constrain the frequency content to less than about 20 Hz while maintaining temporal accuracy. The output of the rhythmic event detector 204 is applied to a periodicity estimator 302.

FIG. 3 depicts a periodicity estimator 302 and a chroma transformer 304 that may be implemented by the digital signal processor of FIG. 1. Periodicity estimation by the periodicity estimator 302 may be performed using a set of tuned comb filters 312 spanning a frequency range of interest. A representative range of the comb filters is about 0.25-4 Hz. A comb filter may be implemented by a difference equation as follows.

yₖ[n]=(1−α)*x[n]+α*yₖ[n−Tₖ]

In one embodiment, the value of α is set to about 0.825 to require a period of regularity before the respective filter will resonate while maintaining the capacity to track modulated tempi. The comb filters compute beat spectra over time for each delay lag Tₖ varied linearly from 50 to 500 samples, inversely spanning the range of 30 to 300 BPM.

Each of the comb filters 312 are cascaded with a band pass filter 322, which may be implemented by a Canny operator similar to that defined above, where σ is a function of L, defined as (2*L−1)/2, and L is in the range of about 0.04*F_{S} to 0.06*F_{S} samples, where F_{S} is the given sample rate. The band pass filters augment the frequency response of the periodicity estimation stage by attenuating the steady-state behavior of the comb filter, effectively lowering the noise floor while suppressing resonance of frequency content in the range of pitch over 20 Hz. The Canny operator may also be corrected by a scalar multiplier to achieve a pass band gain of 0 deci-Bels (dB).

Instantaneous tempo may be calculated by low pass filters 332 which filter the energy of each comb oscillator, where the cut-off frequency of a given low pass filter is set as a function of its respective comb oscillator. In one embodiment, a Hanning window of length Wₖ is applied, where Wₖ is set to correspond to the delay lag of its respective comb-filter channel, according to the following equation.

$${R}_{k} [ n ] = \frac{1}{{W}_{k}} {\sum }_{i = 0}^{{T}_{k} - 1} {w}_{k} [ i ] * {( {y}_{k} [ n - i ] )}^{2}$$

The output of the periodicity estimator 302 includes beat spectra of the sound which is applied to the chroma transformer 304. The chroma transformer 304 includes a transformer 314 that transforms the received beat spectra to a function of frequency that is applied to a scalar 324 which scales the signal by the base 2 logarithm, that may be referenced to about 30 BPM. In some embodiments the reference level may be set at 60 BPM, or 1 Hz. This process may be represented by the following equation.

$$ω = {log}_{2} \frac{BPM}{{BPM}_{refernece}}$$

Identical spectra are summed by summer 334 according to the following equation.

$${Ψ}_{n} [ ω ] = \frac{1}{L} {\sum }_{k = 0}^{L - 1} {R}_{n} [ ω + 2 π * k ]$$

The summation results in rhythmic chroma data that may be plotted by a plotter 344 or displayed in polar coordinates. The rhythmic chroma data is a frequency distribution that exhibits a principal frequency of rhythmic events, the distribution having a width that is proportional to a modulation of the rhythmic events.

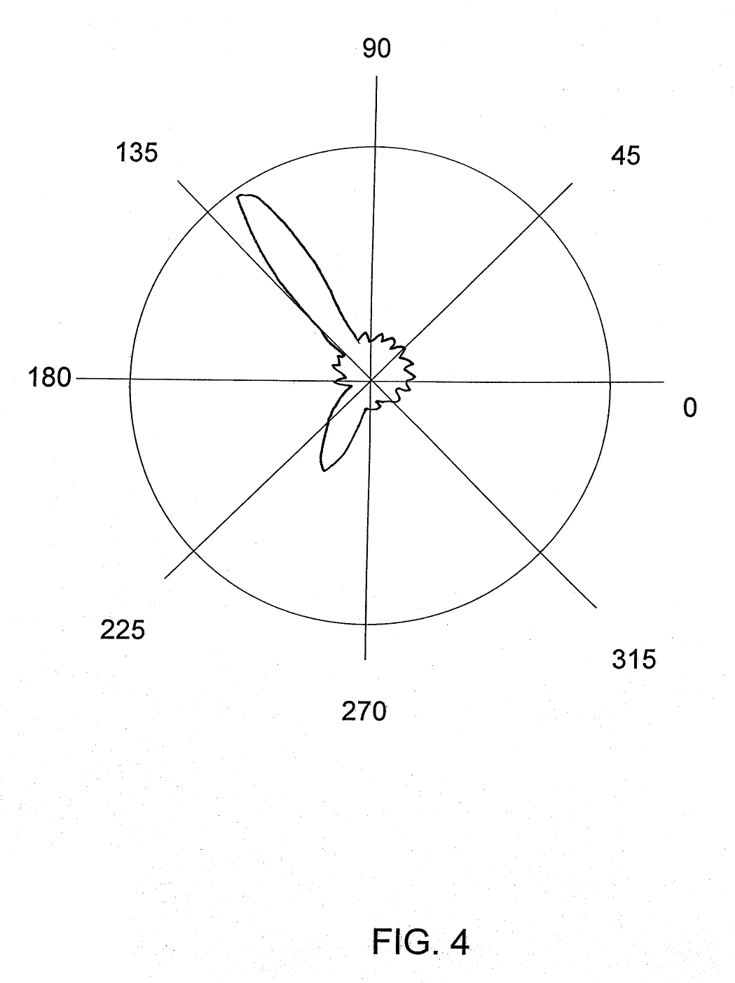

FIG. 4 depicts an example of a distribution of rhythmic chroma data, illustrating a main lobe at about 120 degrees and a minor lobe at about 230 degrees. The magnitude of the peak of the main lobe indicates the beat strength of the received signal. The peak of the main lobe is at a principal frequency of rhythmic events detected in the received signal, where the angle of the main lobe is indicative of the frequency of the main lobe. The width of the main lobe corresponds to an extent of modulation of the rhythmic events. The minor lobe indicates a sub harmonic of the principal frequency. Amplitude ratios of the peak of the fundamental frequency and the harmonics serve as a metric of beat salience; the clarity of the prevailing rhythmic percept.

Thus, one embodiment is a method of characterizing sound that includes receiving an audio signal representative of the sound. The method includes obtaining rhythmic chroma data by processing the audio signal. The rhythmic chroma data includes a distribution associated with a rhythm of the sound. The distribution has a peak amplitude at a principal frequency of rhythmic events and has a width associated with a modulation of the rhythmic events. The method may comprise decomposing an audio signal into sub bands that approximate critical bands of a cochlea to produce sub band waveforms. The number of sub bands may be at least four and usually not more than 25. In some embodiments, each successive sub band width increases logarithmically, base 2. Thus, the audio signal may be processed based on knowledge of the auditory system of a living being, such as a human being.

The audio signal may be band pass filtered to exclude high frequencies while retaining some transitory oscillations. In some embodiments a series of pulses is generated that represent rhythmic events detected in a signal. A periodicity of the pulses may be estimated to obtain rhythmic chroma data. In an illustrative embodiment, obtaining the rhythmic chroma data from the estimated periodicity may include identifying a single octave range of periodicity data. In another illustrative embodiment, the signal may be characterized by cross-correlating rhythmic chroma data extracted from the signal.

Another embodiment is a sound analyzer that includes a digital signal processor configured to extract rhythmic chroma information from a first signal representative of the sound. The rhythmic chroma information has a distribution associated with rhythm embedded in the first signal. The distribution exhibits a peak amplitude at a principle frequency of rhythmic events and exhibits a width associated with a modulation of the rhythmic events. In some embodiments, the digital signal processor is further configured to increase or decrease the rhythm of the sound to match a rhythm embedded in a second signal. The second signal may be a music recording, or a motion signal, for example.

Further, an embodiment may also process the sound to alter a modulation of the rhythmic events. In an illustrative embodiment, different sound signals may be sorted or classified according to rhythmic chroma data of the sound signal. For example, the sounds may be sorted according to increasing or decreasing peak frequency and/or according to increasing or decreasing distribution width. As a further example, the sounds may be sorted based on a ratio of peak amplitudes, or based on a value of an auto correlation of rhythmic chroma data, or based on a cross correlation of rhythmic chroma data of the sound signal and rhythmic chroma data of a reference signal.

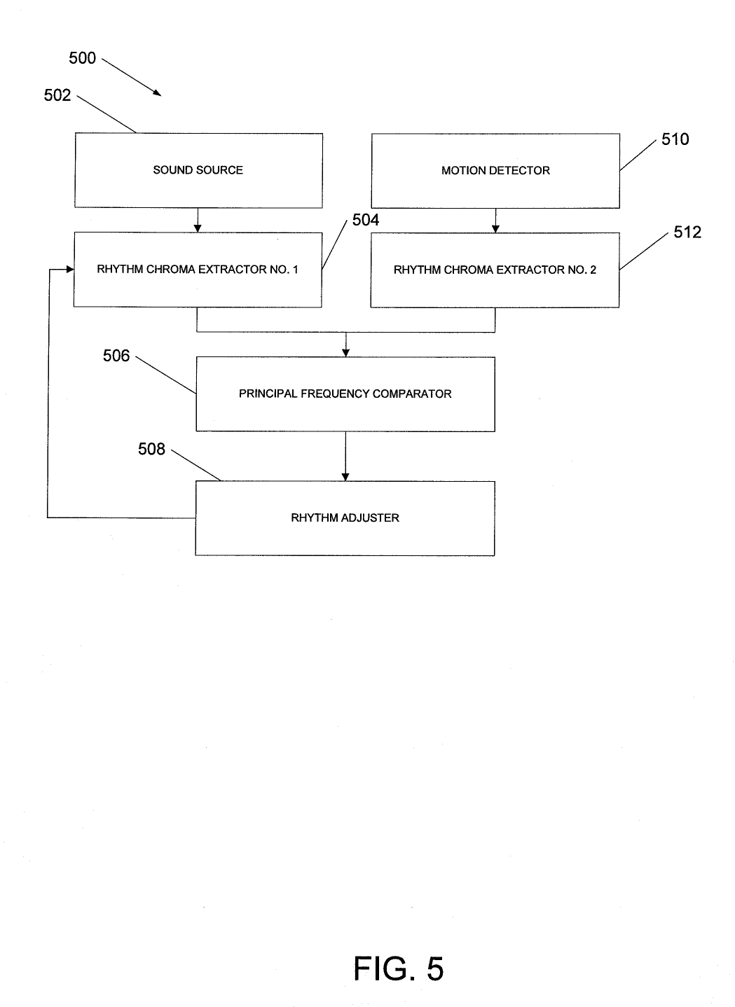

FIG. 5 depicts a system 500 for matching a rhythmic frequency of music to a rhythmic frequency of motion. A music source 502 provides a first signal to be analyzed by a first rhythm chroma extractor 504. The first rhythm chroma extractor 504 may be implemented as described above. A motion detector 510, such as an accelerometer worn by a person who is exercising, provides a second signal to be analyzed by a second rhythm chroma extractor 512. The second rhythm chroma extractor 512 may be implemented substantially as described above, but without the cochlear modeler 102.

The output of the first rhythm chroma extractor 504 includes a principal frequency of rhythmic events detected in the signal from the music source 502. The output of the second rhythm chroma extractor 512 includes a principal frequency of rhythmic events detected in the signal from the motion detector 510. The principal frequencies output by the first and second rhythm chroma extractors are compared by a frequency comparator 506. A rhythm adjuster 508, such as a time stretching algorithm, adjusts the rhythm of the music until the frequency of the rhythm of the music source 502 matches the frequency of the rhythm of the motion detected by the motion detector 510. Time stretching algorithms are known in the art.

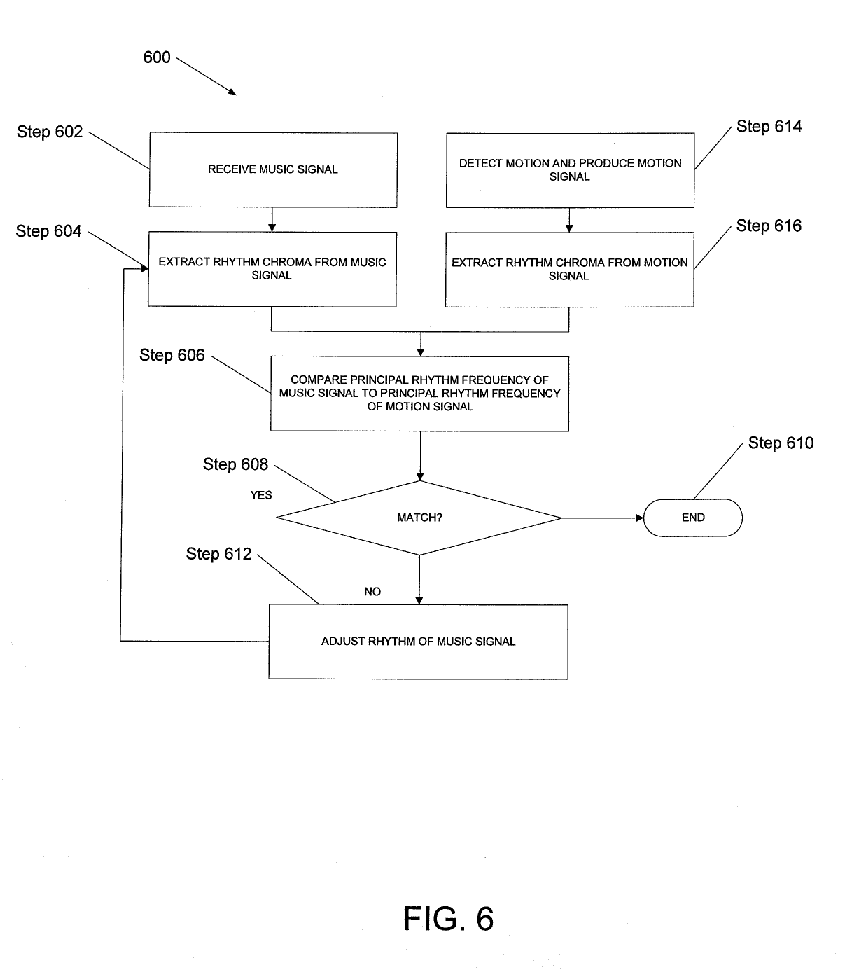

FIG. 6 depicts a flowchart 600 for matching a rhythmic frequency of music to a rhythmic frequency of motion. At step 602 a music signal is received by a first rhythmic chroma detector. At step 604 a first rhythmic chroma detector extracts rhythmic chroma data from the music signal, the rhythmic chroma data exhibiting a first principal frequency. At step 614 a motion detector detects motion and produces an electronic signal indicative of the detected motion. At step 616 a second rhythmic chroma detector extracts rhythmic chroma data from the motion signal, the rhythmic chroma data exhibiting a second principal frequency. At step 606 the first and second principal frequencies are compared. At step 608 a comparator determines if the first principal frequency matches the second principal frequency. If they do not match, at step 612 the rhythm of the music signal is adjusted and the music is reanalyzed by the first rhythmic chroma detector. This process repeats until there is a match, at step 610.

One embodiment is a tangible processor-readable medium having instructions executable by a processor such as the digital signal processor 100 of FIG. 1. Execution of the instructions by the processor causes the processor to extract rhythmic chroma data from a signal such as a music track. Extraction of the rhythmic chroma data may be based on knowledge of an auditory system of a living being. For example, the instructions may cause the processor to filter the signal with filters that approximate critical bands of the a cochlea of an inner ear. Also, the instructions may cause the processor to separate content of the signal into octave sub groups and to identify rhythmic events in each octave sub group. A tangible processor readable medium capable of storing such instructions may include a floppy disc, a hard drive, a flash drive, a compact disk, a digital video disk, read only memory, or random access memory.

Note that although the embodiments described herein contemplate extracting rhythm chroma data from music, other sources of rhythm chroma information may be analyzed by some embodiments described herein, including a machine that produces sound, or voice signals. Also, the methods described herein may be based on knowledge of the auditory system of an animal other than a human being. For example, the sub band decomposer 212 of FIG. 2 may be modeled to emulate a cochlea of an animal other than a human being.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method of characterizing sound, the method comprising:
receiving an audio signal representative of the sound; and
obtaining rhythmic chroma data by processing the audio signal, the rhythmic chroma data including a distribution associated with a rhythm of the sound, the distribution having a peak amplitude at a principal frequency of rhythmic events and having a width associated with a modulation of the rhythmic events.

2. The method of claim 1, wherein the sound is music.

3. The method of claim 1, wherein processing the audio signal includes decomposing the audio signal into subbands to produce subband waveforms.

4. The method of claim 3, wherein the number of subbands is about equal to 22.

5. The method of claim 3, wherein each subband waveform is half-wave rectified and low-pass-filtered to produce a plurality of rhythm event candidates.

6. The method of claim 1, wherein obtaining rhythmic chroma further includes transforming the audio signal to a frequency domain.

7. The method of claim 5, wherein a sliding window of about 50 milliseconds is applied to the rhythm event candidates to substantially eliminate imperceptible rhythm event candidates.

8. The method of claim 5, further comprising:
generating a series of pulses representative of the rhythmic event candidates; and
estimating a periodicity of the series of pulses to obtain the rhythmic chroma data.

9. The method of claim 10, wherein obtaining the rhythmic chroma data from the estimated periodicity comprises identifying a single octave range of periodicity data.

10. The method of claim 1, wherein characterizing the sound includes identifying a peak amplitude of the rhythmic chroma data.

11. The method of claim 1, wherein characterizing the sound includes identifying a width associated with the rhythmic chroma data.

12. A sound analyzer, comprising:
a digital signal processor configured to extract rhythmic chroma information from a first signal representative of the sound, the rhythmic chroma information having a distribution associated with rhythm embedded in the first signal, the distribution exhibiting a peak amplitude at a principal frequency of rhythmic events and exhibiting a width associated with a modulation of the rhythmic events.

13. The sound analyzer of claim 12, wherein the digital signal processor is further configured to process the sound to increase or decrease the principal frequency of the distribution.

14. The sound analyzer of claim 13, wherein increasing or decreasing the principal frequency of the distribution is performed to match the principal frequency of rhythmic events embedded in the first signal to a principal frequency of rhythmic events embedded in a second signal.

15. The sound analyzer of claim 12, wherein the digital signal processor is further configured to process the sound to alter a modulation of the rhythmic events.

16. The sound analyzer of claim 16, wherein the digital signal processor is further configured to sort different sounds based on rhythmic chroma data associated with each of the different sounds.

17. A computer-readable medium storing instructions that when executed by a processor cause the processor to perform a method comprising extracting rhythmic chroma data from a signal, the rhythmic chroma data including a distribution associated with a rhythm of the signal, the distribution having a peak amplitude at a principal frequency of rhythmic events and having a width associated with a modulation of the rhythmic events.

18. The computer-readable medium of claim 17, further comprising analyzing the content by filtering the signal with sub band filters.

19. The computer-readable medium of claim 17, further comprising analyzing the content by dividing the signal into octave subgroups.

20. The computer-readable medium of claim 19, wherein analyzing the content further includes identifying rhythmic events in each octave subgroup.
